(19) United States
(12) Patent Application Publication
(10) Pub. No.: US 2025/0039587 A1
(43) Pub. Date: Jan. 30, 2025

(54) Sound capturing unit

(71) Applicant: SAGEMCOM BROADBAND SAS, Bois-Colombes (FR)

(72) Inventors: Dominique SUSINI, Bois-Colombes (FR); Gilles BOURGOIN, Bois-Colombes (FR); Arnaud FERREIRA, Bois-Colombes (FR)

(21) Appl. No.: 18/764,993

(22) Filed: Jul. 5, 2024

(30) Foreign Application Priority Data
Jul. 24, 2023 (FR) FR2307960

(51) Int. Cl. H04R 1/08; H04R 1/04; H04R 1/40; H04R 3/00

(52) U.S. Cl. CPC H04R 1/086; H04R 1/04; H04R 1/406; H04R 3/005

(57) ABSTRACT

A sound capturing unit includes a cover having a first perforation, a first microphone, a first elastically compressible part having an internal passage, and a first flange which is movable with respect to the cover between assembly and release positions from the cover, The sound capturing unit adopts assembly and release configurations. In the assembly configuration, the first flange compresses the first compressible part and defines a first acoustic chamber between the first perforation and the first microphone by passing through the internal passage of the first compressible part. In the release configuration, the first flange is located in the release position enabling the spacing of the first microphone with respect to the cover.

The present invention relates to the field of sound capturing units.

### BACKGROUND OF THE INVENTION

It is known to capture sounds using microphones placed in a casing, the casing having the function of protecting these microphones.

Such a casing can have a cover having through perforations to enable the passage of sound through the cover.

Each microphone is usually fastened onto a microphone support and is electrically connected to electrical conductors carried by the microphone support to transmit electrical signals representative of sound waves captured by the microphone.

Usually, the microphone support is fastened inside the casing such that the microphone is located facing a corresponding opening which passes through the cover.

Such a fastening of the microphone support is done by gluing the support against an internal part of the casing.

In case of the microphone malfunctioning, it is necessary to remove the microphone support, which takes time and risks causing damage to parts glued to the microphone support.

Recycling such a casing/sound capturing unit is thus difficult to do.

Moreover, the operation of gluing the microphone support is difficult to implement, and is difficult to reproduce, since each glue bead is particular in terms of location, shape, thickness and gluing surface.

Thus, the conditions of capturing sound by a given microphone differ according to the way in which the gluing of the microphone support is done.

### AIM OF THE INVENTION

An aim of the present invention is to provide a sound capturing unit that solves or reduces all or some of the abovementioned disadvantages of the prior art.

### SUMMARY OF THE INVENTION

To this end, the invention mainly relates to a sound capturing unit comprising:
a cover provided with a first cover zone having at least one first perforation passing through the cover;
a first microphone fastened onto a support of the first microphone, the first microphone being electrically connected to electrical conductors carried by the support to transmit electrical signals representative of sound waves captured by the first microphone.

The unit according to the invention is mainly characterized in that it comprises:
a first elastically compressible part having an internal passage opening onto either side of the elastically compressible part; and
a first flange which is movable with respect to the cover between a position of assembling the first flange on a first fastening part belonging to the cover and a position of releasing the first flange from the cover,
   the capturing being unit arranged to selectively adopt an assembly configuration and a release configuration;
   in the assembly configuration, the first flange is located in the assembly position, bearing on the support of the first microphone to compress the first compressible part between the support of the first microphone and the cover, and to define a first acoustic chamber extending from the first perforation of the cover to the first microphone, by passing through the internal passage of the first compressible part;
   in the release configuration, the first flange is located in the release position of the first flange from the cover thus enabling the spacing of the support of the first microphone with respect to the cover.

The capturing unit according to the invention selectively adopts an assembly configuration and a release configuration.

In the assembly configuration, the first flange is located in its assembly position on the cover (in this case, on the first fastening part which belongs to the cover) and it exerts a thrust force on the support of the first microphone, so as to:
on the one hand, compress the first compressible part between this support and the cover; and to
on the other hand, create the first acoustic chamber going from the cover to the support of the first microphone.

This first acoustic chamber only opens towards the first perforation of the cover and towards the first microphone to lead to, via the first acoustic chamber, sound waves passing through the first perforation of the cover up to the first microphone.

Under the effect of its compression between the support of the first microphone and the cover, the first compressible part is deformed about a main axis of the first chamber and it forms an annular seal defining at least partially the first acoustic chamber.

The sound waves arriving up to the first perforation of the cover pass through the cover via the first perforation, then they are guided by the first chamber.

The waves arriving in the first chamber are thus guided to the first microphone, through the first acoustic chamber, about the main axis of the first chamber which passes through the first perforation and through the first microphone.

Through its compressible nature, the compressible part which delimits the periphery of the first acoustic chamber limits the passage of possible acoustic interferences going from the outside to the inside of the first acoustic chamber by following a direction transverse to the main axis of the first acoustic chamber.

In other words, in the assembly configuration, the first flange compresses the first compressible part to define the first sealed acoustic chamber which opens out from a first side of the first compressible part to the first perforation of the cover and from a second side of the first compressible part opens out to the first microphone.

The acoustic sealing between the first compressible part and the support of the first microphone is thus increased by the clamping of the compressible part under the effect of the first flange in the assembly position.

The option of moving the first flange from its assembly position to its release position makes it possible to simply disassemble the first microphone from the cover.

Thus, the operations of maintaining and dismantling/recycling the sound capturing unit according to the invention are simplified.

The unit according to the invention is particularly advantageous, as the cover, the first microphone, the elastically compressible part can be replaced/dismounted independently from one another.

In summary, the sound capturing unit according to the invention enables:
a very good mechanical connection between the support of the first microphone and the cover without having to glue the support of the first microphone against the cover;
a reversibility of the cover/microphone support mechanical connection to facilitate the dismounting of the first microphone from the cover (the first flange is arranged to be moved from its assembly position to its release position, and vice versa);
to create a first acoustic chamber which is correctly insulated over its entire periphery which favours sound transmission, to the first microphone while limiting the risk of sound interference.

The sound capturing unit according to the invention also makes it possible to improve the sound capturing quality, thanks to an acoustic chamber, the features of which remain constant, as long as the first flange is in its assembly position.

### BRIEF DESCRIPTION OF THE DRAWINGS

Other features and advantages of the invention appear clearly from the following description that is given by way of non-limiting indication and with reference to the accompanying drawings, wherein:

FIG. 1a is an exploded, perspective view of a sound capturing unit 1 according to the invention before its assembly using a tool OX specifically suitable for a shape of the flange B1 of the capturing unit 1;

FIG. 1b is a perspective view of the unit of FIG. 1a, while the movement of the first flange B1 from its release position is about to be forced to its 25 assembly position using the tool OX so as to make the unit according to the invention pass from its release configuration to its assembly configuration;

FIG. 2 is a perspective view from below of the tool OX illustrating the shape of the tool OX which is 30 complementary of a shape of the flange B1 so as to couple the tool OX on the flange B1 to move it between its assembly and release positions, without risk that the tool OX comes into contact against the first microphone M1 (the first microphone M1 being protected inside a passage passing through the flange B1);

FIG. 3 is a cross-sectional view of the unit 1 according to the invention, while it is in the assembly configuration, and it is observed in a cutting plane A-A (the orientation of the cutting plane A-A is illustrated in FIG. 1b);

FIG. 4a is a top view of the cover 2, a face of which is seen, intended to be located inside a casing closed by the cover, this cover having through perforations 21, 22 for the passage of sound through the cover and first and second fastening parts respectively disposed to position first and second microphones therein, intended to receive sounds passing through the perforations 21, 22 of the cover;

FIG. 4b is a view similar to FIG. 4a where the cover 2 is seen, on which first and second microphones M1, M2 are positioned, respectively carried by microphone supports Sp1, Sp2, these supports Sp1, Sp2 of the microphones M1, M2 being perforated to enable the passage of pins 23a, 23b belonging to the cover 2, these pins making it possible to precisely locate the microphones M1, M2 with respect to the first and second perforations 21, 22 of the cover 2;

FIG. 4c is a view similar to FIG. 4b where the cover 2 is still seen, the microphones M1, M2 and the supports Sp1, Sp2 of the microphones M1, M2, as well as the first and second flanges B1, B2 in their release positions (the unit 1 is, in this case, in the release configuration), the first flange B1 being disposed to clamp the support Sp1 of the first microphone M1, so as to fixedly position the first microphone M1 with respect to the cover 2 and the second flange B2 being disposed to clamp the support Sp2 of the second microphone M2, so as to fixedly position the second microphone M2 with respect to the cover 2;

FIG. 4d is a view similar to FIG. 4c, where the sound capturing unit 1 according to the invention is seen, placed in the assembly configuration (the sound capturing unit 1 passes from its release configuration which can be seen in FIG. 4c to its assembly configuration which can be seen in FIG. 4d by pivoting, using the tool OX, each given flange B1, B2, from its release position to its assembly position).

### DETAILED DESCRIPTION OF THE INVENTION

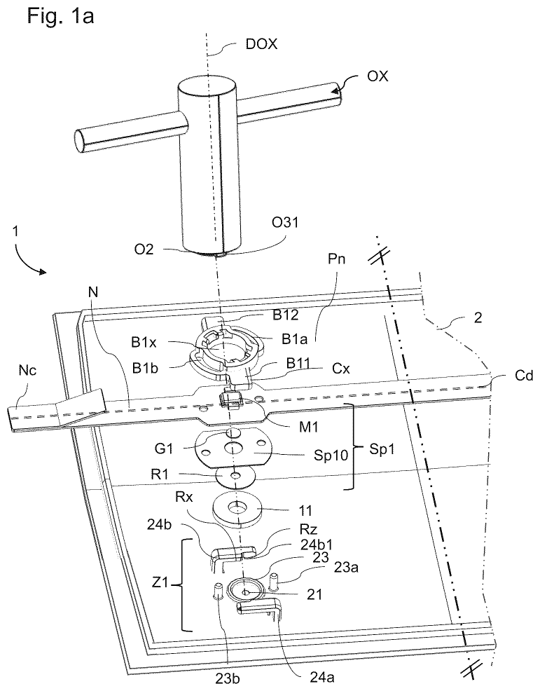

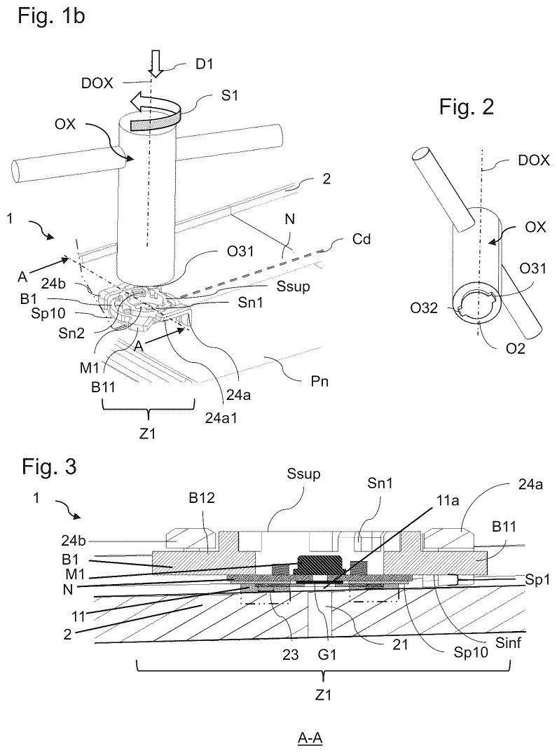

As illustrated in FIGS. 1a, 1b and 1c, the invention relates to a sound capturing unit 1.

the sound capturing unit 1 according to the invention comprises:
a cover 2 provided with a first cover zone Z1 having at least one first perforation 21 passing through the cover 2;
a first microphone M1 fastened onto a support Sp1 of the first microphone, the first microphone M1 being electrically connected to electrical conductors Cd carried by the support Sp1 to transmit electrical signals representative of sound waves captured by the first microphone.

The first microphone M1 is fastened/carried by the support Sp1 of the microphone M1 and it is arranged to transmit, via the electrical conductors Cd, the electrical signals representative of the sound waves passing through the first perforation 21 and captured by the first microphone M1.

The capturing unit 1 comprises:
a first elastically compressible part 11 having an internal passage opening onto either side of the elastically compressible part 11; and
a first flange B1 which is movable with respect to the cover 2 between a position of assembling the first flange B1 on a first fastening part belonging to the cover 2 and a position of releasing the first flange B1 from the cover 2.

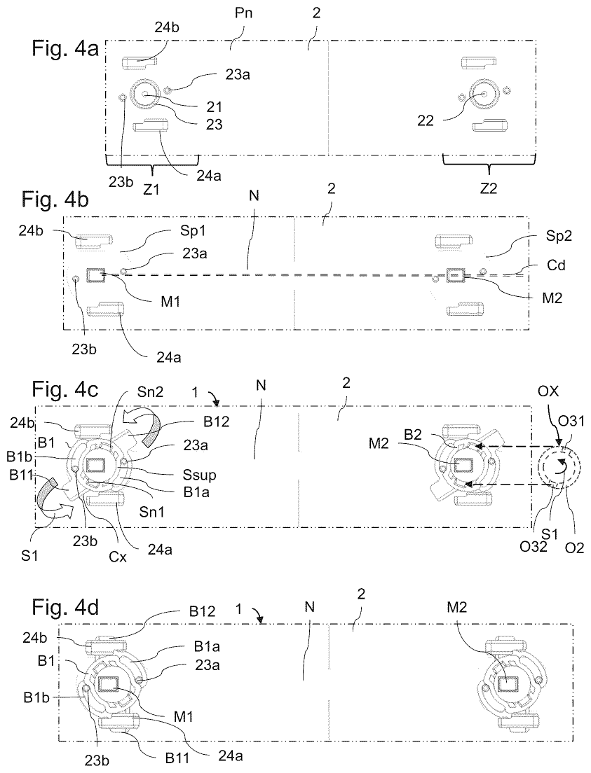

The capturing unit 1 is arranged to selectively adopt an assembly configuration which can be seen in FIGS. 3 and 4d and a release configuration which can be seen in FIGS. 1b and 4c.

In the assembly configuration, the first flange B1 is located in the assembly position, bearing on the support Sp1 of the first microphone M1, to:
compress the first compressible part between the support Sp1 of the first microphone M1 and the cover 2; and to
define a first acoustic chamber 11a extending from the first perforation 21 of the cover 2 up to the first microphone M1 by passing through the internal passage of the first compressible part.

In the release configuration, the first flange B1 is located in the release position of the first flange B1 from the cover 2 thus enabling the spacing of the support Sp1 of the first microphone M1 with respect to the cover.

The first microphone M1 comprises a face which is sensitive to acoustic waves which is oriented directly towards the first acoustic chamber 11a which is at least partially formed in the first compressible part 11 and towards which the first perforation 21 of the cover 2 opens out.

In this way, the sound capturing performed by the first microphone M1 mainly consists of capturing the sounds passing through the first perforation 21 of the cover 2, the other sounds being attenuated by the elastically compressible material of the first compressible part.

Thanks to the invention, like for the first flange B1 and the cover 2 have complementary shapes, enabling a reversible mechanical assembly, the space between the first flange B1 and the cover 2 is fully delimited and invariant, even after several dismountings/remountings of the first flange B1 on the cover 2.

In this way, the compression/deformation degree of the first compressible part 11 is predetermined and is fully reproducible each time that the first flange B1 is assembled on the cover 2 to compress the first compressible part 11.

Thanks to the invention, the acoustic features of the first acoustic chamber 11a and the positioning features of the first microphone M1 with respect to the first acoustic chamber 11a and with respect to the first perforation 21 of the cover 2 are constant and fully reproduced.

The invention therefore offers a solution making it possible to replace the cover 2, or the first flange or the first compressible part, or the first microphone M1 by an identical part, while guaranteeing that one same predetermined set of sound capturing features by sound capturing unit 1 of the invention will always be had.

As can be seen in FIGS. 4c and 4d, the sound capturing unit according to the invention can comprise several microphones, in this case, said first microphone M1 and a second microphone M2, the second microphone M2 being positioned/fastened on the cover 2 in the same way as the first microphone M1.

To simplify FIGS. 1a, 1b and 3, only the first zone of the cover 21 opposite to which the first microphone M1 is positioned, is represented.

However, as can be understood from FIGS. 4a to 4d, the cover 2 is also provided with a second zone Z2 of the cover 2 distinct from said first zone Z1 of the cover, this second zone Z2 having at least one second perforation 22 passing through the cover 2.

The second microphone M2 is fastened onto a support Sp2 of the second microphone M2, the second microphone M2 being electrically connected to electrical conductors Cd carried by the support Sp2 of the second microphone M2 to transmit electrical signals representative of sound waves captured by the second microphone M2.

The capturing unit 1 comprises:
a second elastically compressible part having an internal passing opening out on either side of the second elastically compressible part; and
a second flange B2 which is movable with respect to the cover 2 between a position for assembling the second flange B2 on a second fastening part belonging to the cover 2 and a release position of the second flange from the cover 2.

In the assembly configuration of the unit 1, the second flange B2 is located in the assembly position, bearing on the support Sp2 of the second microphone M2 to compress the second compressible part between the support Sp2 of the second microphone and the cover 2, and to define a second acoustic chamber extending from the second perforation 22 of the cover 2 to the second microphone M2, by passing through the internal passage of the second compressible part.

In the release configuration, the second flange B2 is located in the release position of the second flange B2 from the cover 2 thus enabling the spacing of the support Sp2 of the second microphone M2 with respect to the cover.

The abovementioned advantages of the invention relating to the assembly of the first microphone M1 with respect to the first perforation 21 made at the first zone Z1 of the cover 2 using the flange B1 are transposable mutatis mutandis to the assembly of the second microphone M2 with respect to the second perforation 22 made at the second zone Z2 of the cover 2 using the second flange B2 and of the second elastically compressible part.

In this case, the second cover 2 zone Z2 has shapes which are mainly identical to the shapes of the first zone Z1.

The support Sp2 of the second microphone M2 has shapes which are identical to most of the shapes of the support Sp1 of the first microphone M1.

The first and second microphones M1, M2 have respective substantially equivalent overall volumes, such that each microphone can penetrate into a through passage of either of the flanges B1, B2 when they are assembled with the cover.

The first and second microphones M1, M2 can be electronically identical to one another to have identical sensitivities, but they could also be different to capture sounds over distinct sound ranges.

The electrical conductors Cd carried by the supports Sp1, Sp2 of the first and second microphone M1, M2 extend, in this case, over one same flexible layer N.

As illustrated in FIG. 1a, the flexible layer N has, in this case, an end connected to a layer connector Nc to broadcast the signals transmitted by the conductors Cd to external electronic components.

To simplify the figures, the external electronic components to which the layer connector Nc must be connected are not represented.

The first and second flanges B1, B2 are identical to one another, such that the second flange B2 can be assembled on the cover 2 instead of the first flange and that the first flange B1 can be assembled on the cover 2 instead of the second flange B2.

The first and second deformable parts are also identical to one another, such that they are interchangeable with one another.

Thus, the second flange B2 can be assembled on the cover 2 instead of the first flange B1 and conversely, the first flange B1 can be assembled on the cover 2 instead of the second flange B2.

With this embodiment of the invention, as the flanges B1, B2, the elastically deformable parts and the shapes of the first and second zones Z1, Z2 of the cover are identical to one another, the shapes and the acoustic features of the acoustic chambers respectively formed in the first and second elastically deformable parts 11 are identical to one another.

The invention thus makes it possible to generate, fully reproducibly, acoustic chambers which are mainly identical to one another with a capacity to replace parts constituting the unit according to the invention.

This is particularly useful in terms of facility of mounting/dismounting the unit according to the invention.

Thus, the need to glue the microphones against the cover is removed, thus removing the needs for a step of polymerizing the glue or of checking the gluing.

The assembly of the microphones with respect to the cover is easily reversible by simply moving the flanges.

Thus, the unit 1 according to the invention can be easily maintained/repaired/reconfigured and recycled.

The assembly of the first microphone at the first zone Z1 will now be described in more detail, this description being transposable mutatis mutandis to the assembly of the second microphone at the second zone Z2.

The first compressible part 11 preferably consists of a compressible foam in an axial direction of the internal passage and in a radial direction of the first internal passage.

The deformation in the axial direction of the first compressible part 11 makes it possible to remove the risk of vibrations between the cover 2 and the compressible part 11 and between the compressible part 11 and the support Sp1 of the first microphone M1.

The deformation in the radial direction increases the diameter of the first compressible part 11, the positioning stability of the support Sp1 against the cover 2 thus being improved.

Moreover, increasing the diameter of the first compressible part 11 is also favourable to an absorption of interfering sound waves moving in the radial direction, by going from the outside of the first compressible part to the first acoustic chamber 11a.

In this way, the capturing unit 1 limits the risk of sound interference of the waves captured by the first microphone M1.

Preferably, as can be understood from FIGS. 1a and 3, the support Sp1 of the first microphone M1 comprises a rigidifying plate Sp10 and a flexible layer N subjected to the plate Sp10, the electrical conductors Cd carried by the support Sp1 of the first microphone M1 extending at least partially along the flexible layer N.

In this case, the first microphone M1 is glued on the flexible layer N of the support Sp1 of the first microphone M1, and electrical connections of the first microphone M1 are respectively welded to one of said corresponding electrical conductors Cd which extends along the flexible layer N.

The rigidifying plate Sp10 is perforated in front of the first microphone M1 such that the perforation of the plate Sp10 constitutes a portion of the first acoustic chamber 11a extending between the first microphone M1 and the cover 2.

In this way, the rigidifying plate Sp10 provides a rigidity over the entire periphery of the first acoustic chamber 11a at an interface between the first acoustic chamber 11a and the support Sp1 of the first microphone M1.

This rigidity limits the risk of deterioration of the mechanical junction between the first microphone M1 and the support Sp1 of the first microphone M1.

This localized rigidification is also favourable to the longevity of these electrical connections with the microphone.

Always to preserve the microphone, as illustrated in FIG. 3, a grille G1 protecting against dust is disposed between the sensitive face of the microphone M1 and the first perforation 21. This grille G1 can be glued against the layer N, on the face of a perforation of the layer opening out to the first microphone M1.

For a size gain, this grille G1 is preferably disposed in the perforation of the rigidifying plate Sp10 which is opposite to the first microphone M1.

To improve the connection between the grille G1 and the support Sp1 of the microphone M1, this grille can be glued onto a washer R1, the edges of which are secured to the rigidifying plate Sp10.

As the first microphone M1 precisely is disposed opposite the first perforation 21 of the cover 2, the sound waves passing through the first perforation 21 of the cover 2 are directly directed to the first microphone M1 via the first acoustic chamber 11a by passing through the grille G1.

The first acoustic chamber 11a enables a sound amplification, as it has a precisely defined internal volume, and as it opens out exclusively from a first side to the first perforation 21 of the cover 2, and from a second opposite side to the first microphone M1.

As can be understood from FIGS. 1a, 3 and 4a, the first zone Z1 of the cover 2 comprises an annular rib 23 which surrounds the first perforation 21 of the cover and the first compressible part 11 bears against this annular groove 23.

In this way, the first compressible part 11 which is made of an elastically deformable material, in this case a foam, is elastically deformed against the annular rib 23.

The contact surface between the cover 2 and the first compressible part 11 is thus increased all around the first perforation 21, which is favourable to the sound-proofing between the cover 2 and the first elastically deformable part.

As illustrated in FIGS. 1a, 4a to 4d, the first zone Z1 of the cover 2 also comprises pins 23a, 23b for positioning the support Sp1 of the first microphone M1 which each pass through a corresponding perforation formed in the support Sp1 of the first microphone M1.

These pins prohibit movements of the support Sp1 in directions parallel to a main plane Pn of the cover 2.

In this case, the first zone Z1 of the cover 2 carries two positioning pins 23a, 23b which are fastened onto the cover 2.

Each of these pins 23a, 23b penetrates into a corresponding (circular) perforation of the support Sp1 of the first microphone M1, the perforation passing through the rigidifying plate Sp10 and the layer N.

These pins 23a, 23b also serve as locking tab during the mounting of the first microphone support Sp1 on/against the cover 2 and make it possible to precisely locate the first microphone M1 facing the first perforation of the cover 2.

Preferably, these pins are placed on either side of the first perforation with an alignment between these pins which has its axis offset with respect to a longitudinal axis of the layer N.

The first flange B1 comprises circular arc-shaped openings B1a, B1b disposed such that each positioning pin 23a, 23b penetrates into one of the circular arc-shaped openings B1a, B1b which corresponds to it on the first flange B1.

Each given circular arc-shaped opening B1a, B1b of the first flange B1 is shaped to enable the movement of the first flange B1 between its assembly and release positions, while at least one of said positioning pins is located in the given circular arc-shaped opening B1a, B1b.

In this way, the pins have also a guide function to translate the flange B1 by moving it closer to the cover and a rotation abutment function to define:
a stop position in orientation of the flange B1 which is unique when the flange B1 is in the release position (see FIG. 4c); and
a stop position in orientation of the flange B1 which is unique when the flange B1 is in the assembly position (see FIG. 4d).

The first flange B1 comprises a surface for bearing against the support Sp1 of the first microphone M1 which extends on either side of each of the circular arc-shaped openings B1a, B1b of the first flange B1.

Thus, when the first flange B1 is moved closer to the cover 2 to assemble it onto the cover, each circular arc-shaped opening B1a, B1b constitutes a window for positioning and inserting a positioning pin 23a, 23b.

In this sense, the circular arc-shaped opening B1a assists with the mounting of the first flange B1 on the cover.

Moreover, as the surface for bearing against the support Sp1 of the first microphone M1 extends on either side of each of the circular arc-shaped openings B1a, B1b of the first flange B1, the bearing between the first flange B1 and the support Sp1 of the first microphone M1 is done on either side of each of the pins 23a, 23b.

These features of the first flange B1 and of the positioning pins make it possible to improve the resistance and the positioning precision of the first microphone M1 with respect to the cover 2.

The circular arc shapes of the windows make it possible for the flange to pivot between the release and assembly positions, while the pins 23a, 23b are located in the windows.

Preferably, the windows B1a, B1b have widths, such that during the rotation of the flange B1 from the cover 2, the pins rub against the edges of the windows to thus guide the rotation of the flange. The first fastening part which belongs to the cover 2 comprises first and second tabs 24a, 24b placed on either side of the first perforation 21.

The first flange B1 comprises complementary shapes of the first tab 24a and complementary shapes of the second tab 24b disposed such that in the assembly configuration, the first flange B1 axially bears against some of the complementary shapes of the first tab 24a and against some of the complementary shapes of the second tab 24b to hold the first flange B1 in its assembly position by being opposed to any spacing of the first flange B1 with respect to the cover 2 in a first direction D1, which is perpendicular to a main extension plane of the first zone Z1 of the cover 2.

In this case, the main extension plane of the first zone Z1 of the cover 2 and the main plane Pn of the cover 2 are combined, but they could be parallel to one another.

As will be seen below, the tabs 24a and 24b are hook-shaped, against which the arms of the flange B1 in the assembly position press, thus prohibiting said spacing of the first flange B1 with respect to the cover 2 in a first direction D1.

In the case where the first and second tabs 24a, 24b are respectively hook-shaped:
the shapes of the first flange B1 which are complementary of the first tab 24a comprise a first arm B11; and
the shapes of the first flange B1 which are complementary of the second tab 24b comprise a second arm B12.

The first and second arms B11, B12 extend on either side of the first flange B1, such that each of said arms B11, B12 of the first flange B1 can engage with one of the hooks when the capturing unit 1 is in the assembled configuration.

The shapes of the first flange B1 which are complementary to the second tab 24a are in volume identical to the shapes of the first flange B1 which are complementary to the first tab 24a.

In this way, the first flange can adopt two release positions and two assembly positions on the first fastening part.

This makes it possible to simplify the assembly of the first flange B1 on the cover 2, since there are two distinct positions of the first flange B1 with respect to the cover 2 from which the release configuration can be passed from to the assembly configuration.

These two distinct positions are obtained by pivoting the first flange B1 at 180° about its central axis of symmetry.

In addition, the first and second tabs 24a, 24b are spaced apart from one another by a distance which is less than the width of the first flange measured between the terminal ends of the first and second arms B11, B12 of the first flange B1.

In this way, the first and second arms B11, B12 serve:
on the one hand, as a contact surface with the first and second tabs 24a, 24b to exert, via the first and second arms B11, B12, an axial thrust of the first and second tabs 24a, 24b on the first flange B1, in order to compress said first elastically deformable part; and
on the other hand, as radial abutments to limit the pivoting capacity of the first flange with respect to the cover 2 at the only pivoting angle necessary for the movement of the first flange B1 between its release and assembly positions.

Each of the first and second arms B11, B12 of the first flange B1 comprises an inlet chamfer Cx.

The inlet chamfers Cx are each disposed to rub against one of the first or second tabs 24a, 24b while forcing a movement of the first flange B1 to a face of the cover 2 during the passage of the first flange B1 from its release position to its assembly position.

As can be understood from FIGS. 1a and 1b, the first tab 24a comprises a lug 24a1 and the second tab (24b) comprises a lug 24b1.

At least one of said lugs 24a1, 24b1 comprises a chamfer oriented in the direction of the cover 2, said at least one chamfer being arranged such that when the first flange B1 is moved, by rotation with respect to the cover 2, from its release position to its assembly position, the chamfer of the lug 24a1, 24b1 bears against a portion of one of said arms B11, B12 of the first flange B1 to move the first flange B1 closer opposite a flat surface of the cover 2. The flat surface of the cover belongs to said internal face of the cover 2.

Preferably, it can be ensured that the first zone Z1 of the cover 2 comprises surfaces for guiding the movement of the first flange B1 with respect to the cover 2 during its movement from the release position to the assembly position and during its movement from the assembly position to the release position.

As can be understood from FIG. 1b, these guiding surfaces are such that the passage of the first flange B1 from its release position to its assembly position is done along an assembly trajectory comprising:
a first trajectory part consisting of a translation of the first flange B1 in the first direction D1 with the first flange B1 moving closer from the cover 2; followed by
   a second trajectory part combining translation of the first flange B1 in the first direction D1 and rotation of the first flange B1 about the first direction D1, in a first direction of rotation S1; followed by
a third trajectory part comprising at least one rotation of the first flange B1 about the first direction D1 in said direction of rotation (S1).

The first and second trajectory parts make it possible to simply move the first flange B1 closer from the cover 2 to progressively crush/compress the first compressible part against the cover 2 and constitute the acoustic chamber 11a.

The third trajectory part enables, by pivoting of the first flange B1, to block the first flange B1 in its assembly position and thus hold the capturing unit 1 in its assembly configuration, where each microphone is precisely positioned with respect to the cover.

The assembly trajectory comprises a fourth consecutive trajectory part of the third trajectory part and in which the first flange B1 is spaced apart from the cover 2 until axially abutting against axial stops Rx respectively formed on the first and second tabs 24a, 24b, said axial stops Rx each being adjacent to a rotation abutment Rz.

As can be seen in FIG. 1a, each rotation abutment Rz is disposed to oppose any rotation of the first flange B1 in a second direction of rotation opposite said first direction of rotation S1, as the first flange B1 is axially abutted against said axial stops Rx.

The guiding surfaces and the first flange B1 are arranged, such that the passage of the first flange B1 from the assembly position to the release position is done by following an opposite disassembly trajectory of said assembly trajectory.

The first flange B1 comprises:
a central through passage B1x extending through the first flange to receive the first microphone M1 in the passage B1x while having a free space between the first microphone M1 and the first flange;
an upper flat surface Ssup extending into an upper plane;
   a lower flat surface Sinf extending into a lower plane;
the first flange B1 being arranged, such that in the assembly configuration, the first microphone M1 is located exclusively placed between the upper plane and the lower plane.

In this way, the microphone is mechanically preserved in the flange.

As can be understood from FIGS. 1a, 3 and 4c, the central through passage B1x extends in length about a longitudinal axis of the through passage, the first flange B1 comprising at least one pair of orientation surfaces Sn1, Sn2 of the first flange B1 about said longitudinal axis of the through passage B1x.

In this case, these orientation surfaces Sn1, Sn2 are disposed on either side of the passage B1x and are defined in recesses formed in the flange B1 which open out axially to the upper plane, in which the upper surface Ssup extends and radially to the inside of the central through passage B1x.

Finally, the invention relates to a tool OX to control the passage of said sound capturing unit 1 of one of the release or assembly configurations to the other of the release or assembly configurations.

The tool OX, illustrated in FIGS. 1a, 1b, 2 and 4c is shaped to simultaneously bear:
against said upper flat surface Ssup of the first flange; and
against said pair of orientation surfaces Sn1, Sn2 of the first flange while remaining away from a zone of the central through passage B1x where the first microphone M1 is located when said sound capturing unit 1 is in the assembly configuration.

Thus, the tool OX is shaped to mechanically engage against the first flange B1, by axially bearing against said upper flat surface Ssup and radially bearing against said pair of orientation surfaces Sn1, Sn2.

This makes it possible to exert an orientation torque of the first flange B1 with respect to the cover 2 about the first direction D1 (the first direction D1 is perpendicular to the main plane Pn of the cover 2), this torque making it possible to move the first flange between its release and assembly positions.

This tool OX is particularly easy to use, as when it is mechanically engaged with the first flange B1, it is necessarily at a distance from the first microphone M1 which is located in the through passage B1x of the first flange.

The first microphone M1 is thus protected in the passage of the first flange, without any risk of contact between the tool and the first microphone.

The tool thus makes it possible to simplify the assembly and the disassembly of the first flange to/from the cover 2 while preserving the microphone M1 against a risk of accidental contact which can degrade it.

In other words, the shape of the tool OX is such that when it is mechanically engaged with the first flange to control the movement between its release and assembly positions, the tool is necessarily located at a distance from the first microphone M1.

To this end, the tool OX comprises:
an annular axial bearing surface O2 to bear against the upper flat surface Ssup of the first flange B1; and
lugs O31, O32 defining radial surfaces of the tool OX to respectively bear against the orientation surfaces Sn1, Sn2 of the first flange B1.

The tool is, in this case, a manual tool which comprises two diametrically opposite arms O41, O42 to exert an orientation torque of the tool about a longitudinal axis DOX of the tool OX to drive the rotation of the first flange with respect to the cover 2 (this rotation of the first flange is done about the axial direction of the internal passage of the first flange which is parallel and combined with the central axis of symmetry of the first flange).

However, thanks to the specific features of the unit according to the invention, the operations of fastening the microphones with respect to the cover are very simple to perform/reproduce and it is thus possible to mount microphones and flanges on the cover using a robotic arm.

The passage B1x wherein the microphone M1 is located, also makes it possible to favour sound capturing, through the first microphone M1, since the sounds arriving on the first microphone M1 without passing through the first acoustic chamber 11a are attenuated by the presence of the flange around the microphone.

This feature is favourable to an improvement of the sound capturing quality by the first microphone M1.

The capturing unit 1 is preferably a speaker casing or a communication casing, the unit comprising at least one board for communication with a network which is external to the capturing unit 1 to broadcast a signal representative of the sound waves captured by the first 5 microphone M1.

The cover of the unit 1 is a cover for blocking an opening of the casing.

In any one of the embodiments where the sound capturing unit 1 is a speaker casing or a communication casing or a communication casing integrating a speaker, such a casing also contains electronic components for processing electrical signals produced by the microphone(s) and to broadcast these signals.

1. A sound capturing unit, comprising:
a cover provided with a first cover zone having at least one first perforation passing through the cover;
a first microphone fastened onto a support of the first microphone, the first microphone being electrically connected to electrical conductors carried by the support to transmit electrical signals representative of sound waves captured by the first microphone;
a first elastically compressible part having an internal passage opening onto either side of the elastically compressible part; and
a first flange which is movable with respect to the cover between a position of assembling the first flange on a first fastening part belonging to the cover and a position of releasing the first flange from the cover, wherein
the sound capturing unit is arranged to selectively adopt an assembly configuration and a release configuration;
in the assembly configuration, the first flange is located in the assembly position, bearing on the support of the first microphone to compress the first compressible part between the support of the first microphone and the cover, and to define a first acoustic chamber extending from the first perforation of the cover to the first microphone, by passing through the internal passage of the first compressible part;
in the release configuration, the first flange is located in the release position of the first flange from the cover, thus enabling the spacing of the support of the first microphone with respect to the cover, the first fastening part belonging to the cover comprising first and second tabs placed on either side of the first perforation, the first flange comprising complementary shapes of the first tab and complementary shapes of the second tab disposed such that in the assembly configuration, the first flange axially bears against some of the complementary shapes of the first tab and against some of the complementary shapes of the second tab to hold the first flange in its assembly position by being opposed to any spacing of the first flange with respect to the cover in a first direction, which is perpendicular to a main extension plane of the first zone of the cover.

2. The sound capturing unit according to claim 1, wherein the first compressible part consists of a compressible foam in an axial direction of the internal passage and in a radial direction of the first internal passage.

3. The sound capturing unit according to claim 1, wherein the support of the first microphone comprises a rigidifying plate and a flexible layer secured to the rigidifying plate, the electrical conductors carried by the support of the first microphone extending at least partially along the flexible layer.

4. The sound capturing unit according to claim 3, wherein the rigidifying plate is perforated in front of the first microphone such that the perforation of the plate constitutes a portion of the first acoustic chamber extending between the first microphone and the cover.

5. The sound capturing unit according to claim 1, wherein the first microphone is disposed opposite to the first perforation of the cover.

6. The sound capturing unit according to claim 1, wherein said first zone of the cover comprises an annular rib which surrounds the first perforation of the cover, the first compressible part bearing against the annular rib of the first zone of the cover.

7. The sound capturing unit according to claim 1, wherein the first zone of the cover comprises pins for positioning the support of the first microphone each passing through a corresponding perforation formed in the support of the first microphone to prohibit movements of the support of the first microphone in directions parallel to a main plane of the cover.

8. The sound capturing unit according to claim 7, wherein the first flange comprises circular arc-shaped openings disposed such that each positioning pin penetrates in one of the circular arc-shaped openings which corresponds to it on the first flange, each given circular arc-shaped opening of the first flange being shaped to enable the movement of the first flange between its assembly and release positions while at least one of said positioning pins is located in the given circular arc-shaped opening, the first flange comprising a surface for bearing against the support of the first microphone which extends on either side of each of the circular arc-shaped openings of the first flange.

9. The sound capturing unit according to claim 1, wherein the first zone of the cover comprises surfaces for guiding the movement of the first flange with respect to the cover during its movement from the release position to the assembly position and during its movement from the assembly position to the release position, these guiding surfaces being such that the passage of the first flange from its release position to its assembly position is done along an assembly trajectory, comprising:
a first trajectory part consisting of a translation of the first flange in the first direction with the first flange moving closer from the cover; followed by
a second trajectory part combining translation of the first flange in the first direction and rotation of the first flange about the first direction, in a first direction of rotation; followed by
a third trajectory part comprising at least one rotation of the first flange about the first direction in said first direction of rotation.

10. The sound capturing unit according to claim 9, wherein said assembly trajectory comprises a fourth consecutive trajectory part of the third trajectory part and wherein the first flange is spaced apart from the cover until axially abutting against axial stops respectively formed on the first and second tabs, said axial stops each being adjacent from a rotation abutment, each rotation abutment is disposed to oppose any rotation of the first flange in a second direction of rotation opposite said first direction of rotation as the first flange is axially abutted against said axial stops.

11. The sound capturing unit according to claim 1, wherein:
the first and second tabs are respectively hook-shaped;
the shapes of the first tab which are complementary of the first tab comprise a first arm; and
the shapes of the first flange which are complementary of the second tab comprise a second arm, the first and second arms extending on either side of the first flange, such that each of said arms of the first flange can engage with one of the hooks when the sound capturing unit is in the assembled configuration.

12. The sound capturing unit according to claim 11, wherein each of the first and second arms of the first flange comprises an inlet chamfer, the inlet chamfers each being disposed to rub against one of the first or second tabs while forcing a movement of the first flange to a face of the cover during the passage of the first flange from its release position to its assembly position.

13. The sound capturing unit according to claim 1, wherein the first tab comprises a lug and the second tab comprises a lug, at least one of said lugs comprising a chamfer oriented in the direction of the cover, said at least one chamfer is arranged such that when the first flange is moved, by rotation with respect to the cover, from its release position to its assembly position, the chamfer of the lug bears against a portion of one of said arms of the first flange to move the first flange closer with respect to a flat surface of the cover.

14. The sound capturing unit according to claim 1, wherein:
the cover is provided with a second zone of the cover distinct from said first zone of the cover and having at least one second perforation passing through the cover;
a second microphone fastened onto a support of the second microphone (M2), the second microphone being electrically connected to electrical conductors carried by the support of the second microphone to transmit electrical signals representative of sound waves captured by the second microphone, the sound capturing unit further comprising:
a second elastically compressible part having an internal passage opening onto either side of the second elastically compressible part; and
a second flange which is movable with respect to the cover between a position of assembling the second flange on a second fastening part belonging to the cover and a position of releasing the second flange from the cover,
in the assembly configuration, the second flange is located in the assembly position, bearing on the support of the second microphone to compress the second compressible part between the support of the second microphone and the cover, and to define a second acoustic chamber extending from the second perforation of the cover to the second microphone, by passing through the internal passage of the second compressible part;
in the release configuration, the second flange is located in the release position of the second flange with respect to the cover thus enabling the spacing of the support of the second microphone with respect to the cover.

15. The sound capturing unit according to claim 1, wherein the sound capturing unit is a speaker casing or a communication casing, the sound capturing unit further comprising at least one communication board with a network which is external to the sound capturing unit to broadcast a signal representative of the sound waves captured by the first microphone, said cover being a cover for blocking an opening of the casing.

16. The sound capturing unit according to claim 1, wherein the first flange comprises:
a central through passage extending through the first flange to receive the first microphone in the passage, while having a free space between the first microphone and the first flange;
an upper flat surface extending into an upper plane;
a lower flat surface extending into a lower plane;
the first flange being arranged such that in the assembly configuration, the first microphone is located exclusively placed between the upper plane and the lower plane.

17. The sound capturing unit according to claim 16, wherein said central through passage extends in length about a longitudinal axis of the through passage, the first flange comprising at least one pair of orientation surfaces of the first flange about said longitudinal axis of the through passage.

18. A kit comprising the sound capturing unit according to claim 17 and a tool to control the passage of said sound capturing unit from one of the release or assembly configurations to the other of the release or assembly configurations, the tool being shaped to simultaneously bear:
against said upper flat surface of the first flange; and
against said pair of orientation surfaces of the first flange while remaining away from a zone of the central through passage where the first microphone is located when said sound capturing unit is in the assembly configuration.
